(19) United States
(12) Patent Application Publication
(10) Pub. No.: US 2024/0386795 A1
(43) Pub. Date: Nov. 21, 2024

(54) TRAFFIC CAMERA-BASED DETERMINATION OF TRAFFIC SIGNAL-TO-LANE ASSOCIATION FOR AUTOMATED VEHICLE OPERATION

(71) Applicant: QUALCOMM Incorporated, San Diego, CA (US)

(72) Inventors: Dan VASSILOVSKI, Del Mar, CA (US); Kyle Chi GUAN, New York, NY (US); Gene Wesley MARSH, San Diego, CA (US)

(21) Appl. No.: 18/320,935

(22) Filed: May 19, 2023

(51) Int. Cl. G08G 1/01; G06V 20/54; G08G 1/0967; H04W 4/44

(52) U.S. Cl. CPC G08G 1/0141; G06V 20/54; G08G 1/0116; G08G 1/096725; H04W 4/44; G06V 2201/08

(57) ABSTRACT

An example method comprises obtaining information regarding a motion of a vehicle traversing the traffic intersection during a time window using video frames or image frames of the vehicle obtained by a traffic camera, obtaining roadway delineation information indicative of a traffic lane at the traffic intersection, wherein the roadway delineation information corresponds to the motion of the vehicle as indicated in the video frames or image frames of the vehicle obtained by the traffic camera, obtaining traffic light information of a traffic light at the traffic intersection, the traffic light information corresponding to the time window during which the vehicle traverses the traffic intersection, wherein the traffic light information indicates timing of the traffic light, and determining the traffic signal-to-lane association by using the information regarding the motion of the vehicle, the roadway delineation information, and the traffic light information to associate the traffic lane with the traffic light.

### BACKGROUND

### 1. Field of Disclosure

The present disclosure relates generally to the field of traffic management, and more specifically, to a method for determining traffic signal-to-lane associations using traffic camera data in order to facilitate the operation of autonomous vehicles.

### 2. Description of Related Art

As the development of autonomous vehicles (AVs) continues to gain momentum, successfully navigating complex, multi-lane intersections with multiple traffic signal lights can be challenging because determining the appropriate traffic light to comply with when approaching or stopped at an intersection can be a challenge for AVs and even for human driver. AVs, which typically rely on front-facing, fixed-direction cameras for detection of features, objects, road users, etc. in front of the vehicle, face difficulties in accurately interpreting the traffic signals governing specific lanes.

### BRIEF SUMMARY

An example method of traffic camera-based determination of traffic signal-to-lane association of a traffic intersection for automated vehicle operation, the method performed by a server and may comprise obtaining information regarding a motion of a vehicle traversing the traffic intersection during a time window using video frames or image frames of the vehicle obtained by a traffic camera and obtaining roadway delineation information indicative of a traffic lane at the traffic intersection, wherein the roadway delineation information corresponds to the motion of the vehicle as indicated in the video frames or image frames of the vehicle obtained by the traffic camera. The method may also comprise obtaining traffic light information of a traffic light at the traffic intersection, the traffic light information corresponding to the time window during which the vehicle traverses the traffic intersection, wherein the traffic light information indicates timing of the traffic light and determining the traffic signal-to-lane association by using the information regarding the motion of the vehicle, the roadway delineation information, and the traffic light information to associate the traffic lane with the traffic light. The method may further comprise disseminating the traffic signal-to-lane association to an automated vehicle (AV) for the AV to navigate the traffic intersection.

An example server for traffic camera-based determination of traffic signal-to-lane association of a traffic intersection for automated vehicle operation, the radar unit comprising a transceiver, a memory, and one or more processors communicatively coupled with the transceiver and the memory. The one or more processors may be configured to obtain information regarding a motion of a vehicle traversing the traffic intersection during a time window using video frames or image frames of the vehicle obtained by a traffic camera and obtain roadway delineation information indicative of a traffic lane at the traffic intersection, wherein the roadway delineation information corresponds to the motion of the vehicle as indicated in the video frames or image frames of the vehicle obtained by the traffic camera. The one or more processors may also be configured to obtain traffic light information of a traffic light at the traffic intersection, the traffic light information corresponding to the time window during which the vehicle traverses the traffic intersection, wherein the traffic light information indicates timing of the traffic light and determine the traffic signal-to-lane association by using the information regarding the motion of the vehicle, the roadway delineation information, and the traffic light information to associate the traffic lane with the traffic light. The one or more processors may further be configured to disseminate the traffic signal-to-lane association to an automated vehicle (AV) for the AV to navigate the traffic intersection.

An example apparatus for traffic camera-based determination of traffic signal-to-lane association of a traffic intersection for automated vehicle operation, the apparatus may comprise means for obtaining information regarding a motion of a vehicle traversing the traffic intersection during a time window using video frames or image frames of the vehicle obtained by a traffic camera and means for obtaining roadway delineation information indicative of a traffic lane at the traffic intersection, wherein the roadway delineation information corresponds to the motion of the vehicle as indicated in the video frames or image frames of the vehicle obtained by the traffic camera. The apparatus may also comprise means for obtaining traffic light information of a traffic light at the traffic intersection, the traffic light information corresponding to the time window during which the vehicle traverses the traffic intersection, wherein the traffic light information indicates timing of the traffic light and means for determining the traffic signal-to-lane association by using the information regarding the motion of the vehicle, the roadway delineation information, and the traffic light information to associate the traffic lane with the traffic light. The apparatus may further comprise means for disseminating the traffic signal-to-lane association to an automated vehicle (AV) for the AV to navigate the traffic intersection.

An example non-transitory computer-readable medium storing instructions for traffic camera-based determination of traffic signal-to-lane association of a traffic intersection for automated vehicle operation, the instructions may comprise code for obtaining information regarding a motion of a vehicle traversing the traffic intersection during a time window using video frames or image frames of the vehicle obtained by a traffic camera and obtaining roadway delineation information indicative of a traffic lane at the traffic intersection, wherein the roadway delineation information corresponds to the motion of the vehicle as indicated in the video frames or image frames of the vehicle obtained by the traffic camera. The instructions may also comprise code for obtaining traffic light information of a traffic light at the traffic intersection, the traffic light information corresponding to the time window during which the vehicle traverses the traffic intersection, wherein the traffic light information indicates timing of the traffic light and determining the traffic signal-to-lane association by using the information regarding the motion of the vehicle, the roadway delineation information, and the traffic light information to associate the traffic lane with the traffic light. The instructions may further comprise code for disseminating the traffic signal-to-lane association to an automated vehicle (AV) for the AV to navigate the traffic intersection.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a system in which vehicles may communicate over various networks and with various devices, vehicles, and servers, according to an embodiment.

FIG. 2 illustrates an example scenario of traffic intersection 200 where traffic signal-to-lane association are needed

FIG. 3 is a high-level block diagram of a method of determining a traffic signal-to-lane association, according to an embodiment.

FIG. 4 is an example of an information element (IE) definition, according to an embodiment.

FIG. 5 is a flow diagram of a method of traffic camera-based determination of traffic signal-to-lane association of a traffic intersection for automated vehicle operation, according to some embodiments.

FIG. 6 is a block diagram of an embodiment of a computer system.

FIG. 7 is a block diagram of an embodiment of a V2X device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used, and various modifications may be made without departing from the scope of the disclosure.

As referred to herein, “V2X devices,” “V2X vehicles,” and “V2X entities” respectively refer to devices, vehicles, and entities capable of transmitting and receiving V2X messages. Similarly, “non-V2X vehicles” and “non-V2X entities” refer to vehicles and entities that do not or cannot engage in V2X communications. Further, a “V2X device,” which is described in more detail herein, refers to a device, system, component, or the like which may be incorporated into and/or used by a V2X entity to enable V2X communications. Although many embodiments describe “V2X vehicles” and “non-V2X vehicles,” it will be understood that many embodiments can be expanded to include non-vehicle entities, such as pedestrians, cyclists, road hazards, obstructions, and/or other traffic-related objects. Further, it can be noted that embodiments may apply to vehicles and/or RSUs capable of traffic-related communication, and not necessarily to V2X-capable vehicles/RSUs. Moreover, although the embodiments provided herein can be executed by autonomous and/or semi-autonomous vehicles, embodiments are not so limited. Embodiments may, for example, include traditional (non-autonomous) vehicles having capabilities for determining and communicating intended maneuvers (e.g., within on-board navigation computer, capable of communicating instructions to a human driver). A person of ordinary skill in the art will appreciate such variations.

Various aspects relate generally to the field of traffic management, and more specifically, to a method for determining traffic signal-to-lane associations using traffic camera data in order to facilitate the operation of AVs. In some examples, traffic camera-obtained data may be used to determine the association of traffic signal lights with corresponding traffic lanes at an intersection, ultimately aiding AV navigation. For example, a cloud-based server may obtain a motion of a vehicle at the intersection using traffic camera(s). The cloud-based server may also obtain roadway delineation information (e.g., road marking, traffic lanes, etc.) at the intersection of interest corresponding to the motion of the vehicle and may obtain traffic light information that indicates timing of a traffic light at the traffic intersection, corresponding to the time window during which the vehicle traverses the traffic intersection. Accordingly, the traffic signal-to-lane association for a traffic lane and a traffic light at the intersection of interest may be determined by using the information regarding the motion of the vehicle, the roadway delineation information, and the traffic light information to associate the traffic lane with the traffic light.

In some embodiments, the traffic signal-to-lane association information can be disseminated to AVs through a variety of methods, including a priori provisioning, location-based knowledge provisioning, or via a request-response communication mechanism (e.g., embedded in on-board unit (OBU) application-layer messages or OBU subscription services). The traffic signal-to-lane association information can be transmitted to the AV through various channels, such as wired connections, over-the-air methods like Wi-Fi downloads facilitated by an original equipment manufacturer (OEM) or a commercial cloud-based service, or over-the-air through Uu or V2X communication, using either application-layer or lower-layer messages (e.g., RRC) from a cloud-based service.

Particular aspects of the subject matter described in this disclosure can be implemented to realize one or more of the following potential advantages. In some examples, by utilizing techniques discussed herein, AVs can efficiently obtain and/or update the traffic signal-to-lane association information, enhancing their ability to navigate complex traffic scenarios safely and effectively.

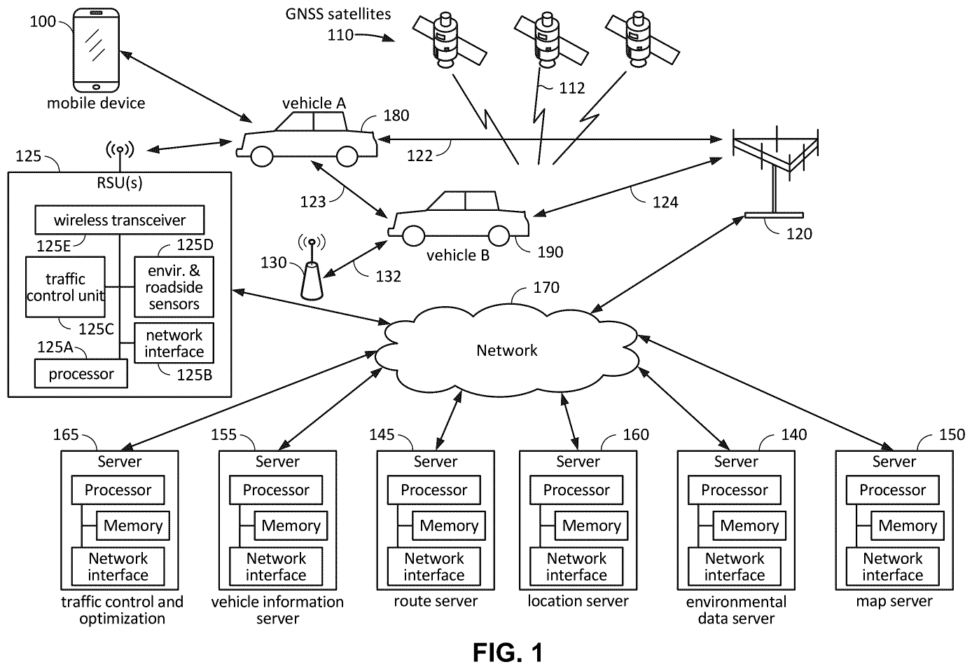

FIG. 1 is an illustration of a system in which vehicles may communicate over various networks and with various devices, vehicles, and servers, according to an embodiment. In an embodiment, V2X vehicle A 180 may communicate with V2X or otherwise communication-transceiver-enabled vehicle B 190, using V2X or other wireless communication transceiver over link 123. Some embodiments may, for example, communicate to perform inter-vehicle relative positioning, negotiation for lane changes, for passage through an intersection, and/or to exchange V2X data elements such as GNSS measurements; vehicle status, vehicle location, and vehicle abilities; measurement data; and/or calculated status. Such communications may additionally or alternatively be used to exchange other V2X vehicle status steps that may not be covered in the V2X capability data elements.

In some embodiments, vehicle A 180 may also communicate with vehicle B 190 through a network. This can be done using wireless signals 122/124 to/from base station 120 and/or via wireless signals 132 to/from an access point 130. Additionally or alternatively, such communication can be done via one or more communication-enabled RSU(s) 125, any of which may relay communication and information, and/or convert protocols for use by other vehicles, such as vehicle B 190. This latter functionality can be done, for example, in an embodiment where vehicle B 190 is not capable of communicating directly with vehicle A 180 in a common protocol. In an embodiment, RSU(s) 125 may comprise various types of roadside beacons, traffic and/or vehicular monitors, traffic control devices, and location beacons.

In an embodiment, RSU(s) 125 may have a processor 125A configured to operate wireless transceiver 125E to send and receive wireless messages, for example, a BSM, CAM, or other V2X messages to/from vehicle A 180 and/or vehicle B 190, from base station 120 and/or access point 130. For example, wireless transceiver 125E may send and/or receive wireless messages in various protocols such as V2X communication with vehicles (e.g., using sidelink communication), and/or using various WAN, Wireless Local Area Network (WLAN), and/or Personal Area Network (PAN) protocols to communicate over a wireless communication network. In an embodiment, RSU(s) 125 may contain one or more processors 125A communicatively coupled to wireless transceiver 125E and memory and may contain instructions and/or hardware to perform as a traffic control unit 125C and/or to provide and/or process environmental and roadside sensor information 125D or to act as a location reference for GNSS relative location between it and vehicles. In an embodiment, RSU(s) 125 may contain a network interface 125B (and/or a wireless transceiver 125E), which, in an embodiment, may communicate with external servers such as traffic optimization server 165, vehicle information server 155, and/or environmental data server 140. In an embodiment, wireless transceiver 125E may communicate over a wireless communication network by transmitting or receiving wireless signals from a wireless Base Transceiver Subsystem (BTS), a NodeB or an evolved NodeB (eNodeB) or a next-generation NodeB (gNodeB) over wireless communication link. In an embodiment, wireless transceiver(s) 125E may comprise various combinations of WAN, WLAN, and/or PAN transceivers. In an embodiment, a local transceiver may also be a Bluetooth® transceiver, a ZigBee transceiver, or other PAN transceiver. A local transceiver, a WAN wireless transceiver, and/or a mobile wireless transceiver may comprise a WAN transceiver, an access point (AP), femtocell, Home Base Station, small cell base station, Home NodeB (HNB), Home eNodeB (HeNB), or next-generation NodeB (gNodeB), and may provide access to a WLAN (e.g., IEEE 1102.11 network), a wireless PAN (e.g., Bluetooth® network), or a cellular network (e.g., an LTE network or other wireless WAN such as those discussed in the next paragraph). It should be understood that these are merely examples of networks that may communicate with RSU(s) 125 over a wireless link, and claimed subject matter is not limited in this respect.

RSU(s) 125 may receive location, status, GNSS and other sensor measurements, and capability information from vehicle A 180 and/or vehicle B 190, such as GNSS measurements, sensor measurements, velocity, heading, location, stopping distance, priority or emergency status, and other vehicle-related information. In an embodiment, environmental information such as road surface information/status, weather status, and camera information may be gathered and shared with vehicles, either via point-to-point or broadcast messaging. RSU(s) 125 may utilize received information, via wireless transceiver 125E, from vehicle A 180 and/or vehicle B 190, environmental and roadside sensors 125D, and network information and control messages from, for example, traffic control and optimization server 165 to coordinate and direct traffic flow and to provide environmental, vehicular, safety, and announcement messages to vehicle A 180 and vehicle B 190.

Processor 125A may be configured to operate a network interface 125B, in an embodiment, which may be connected via a backhaul to network 170, and which may be used, in an embodiment, to communicate and coordinate with various centralized servers such as a centralized traffic control and optimization server 165 that monitors and optimizes the flow of traffic in an area, such as within a city or a section of a city or in a region. Network interface 125B may also be utilized for remote access to RSU(s) 125 for crowdsourcing of vehicle data, maintenance of the RSU(s) 125, and/or coordination with other RSU(s) 125 or other uses. RSU(s) 125 may have a processor 125A configured to operate traffic control unit 125C, which may be configured to process data received from vehicles such as vehicle A 180 and vehicle B 190, such as location data, stopping distance data, road condition data, identification data, and other information related to the status and location of nearby vehicles and environment. RSU(s) 125 may have a processor 125A configured to obtain data from environmental and roadside sensors 125D, which may include temperature, weather, camera, pressure sensors, road sensors (e.g., for car detection), accident detection, movement detection, speed detection, and other vehicle and environmental monitoring sensors.

In an embodiment, vehicle A 180 may also communicate with mobile device 100 using short-range communication and personal networks such as Bluetooth®, Wi-Fi, or Zigbee, or via V2X (e.g., CV2X/sidelink communications) or other vehicle-related communication protocols, for example, in an embodiment, to access WAN and/or Wi-Fi networks, and/or, in an embodiment, to obtain sensor and/or location measurements from mobile device 100. In an embodiment, vehicle A 180 may communicate with mobile device 100 using WAN-related protocols through a WAN, such as via WAN base station 120 or using Wi-Fi either directly peer to peer or via a Wi-Fi access point. Vehicle A 180 and/or vehicle B 190 may communicate using various communication protocols. In an embodiment, vehicle A 180 and/or vehicle B 190 may support various and multiple modes of wireless communication, such as, for example, using V2X, Global System for Mobile Communications (GSM), Wideband Code-Division Multiple Access (WCDMA), Code-Division Multiple Access (CDMA), High-Rate Packet Data (HRPD), Wi-Fi, Bluetooth®, WiMAX, LTE, or 5G NR access technology communication protocols.

In an embodiment, vehicle A 180 may communicate over WANs using WAN protocols via WAN base station 120 or with WLAN access point 130 using WLAN protocols such as Wi-Fi. A vehicle may also support wireless communication using a WLAN or PAN (such as Bluetooth® or ZigBee), for example.

Vehicle A 180 and/or vehicle B 190, in an embodiment, may contain one or more GNSS receivers, such as a GNSS receiver for reception of GNSS signals 112 from GNSS satellites 110 for location determination, time acquisition, and time maintenance. Various GNSS systems may be supported alone or in combination, using the GNSS receiver or other receiver, to receive signals from Beidou, Galileo, GLObal NAvigation Satellite System (GLONASS), and/or GPS, and various regional navigational systems such as Quasi-Zenith Satellite System (QZSS) and Indian Regional Navigation Satellite System (IRNSS) or NavIC. Other wireless systems may be utilized, such as those depending on beacons such as, in an example, one or more RSU(s) 125, one or more WLAN access points 130, or one or more base stations 120. Various GNSS signals 112 may be utilized in conjunction with car sensors to determine location, velocity, and proximity to other vehicles, such as between vehicle A 180 and vehicle B 190.

In an embodiment, vehicle A and/or vehicle B may access GNSS measurements and/or locations determined at least in part using GNSS as provided by mobile device 100, which, in an embodiment, would also have GNSS, WAN, Wi-Fi, and other communications receivers and/or transceivers. In an embodiment, vehicle A 180 and/or vehicle B 190 may access GNSS measurements (such as pseudorange measurements, Doppler measurements, and satellite IDs) and/or locations determined at least in part using GNSS as provided by mobile device 100 as a fallback in case the GNSS receiver fails or provides less than a threshold level of location accuracy.

Vehicle A 180 and/or vehicle B 190 may access various servers on the network, such as vehicle information server 155, route server 145, location server 160, map server 150, and environmental data server 140.

Vehicle information server 155 may provide information describing various vehicles, such as antenna location, vehicle size, and vehicle capabilities, as may be utilized in making decisions in regard to maneuvers relative to nearby cars, such as whether they are capable of stopping or accelerating in time or whether they are autonomously driven, autonomous-driving capable, or communications capable. In an embodiment, vehicle information server 155 may also provide information in regard to vehicle size, shape, capabilities, identification, ownership, occupancy, and/or determined location point (e.g., the location of the GNSS receiver) and the location of the car boundaries relative to the determined location point.

Route server 145 may receive current location and destination information, and provide routing information for the vehicle, map data, alternative route data, and/or traffic and street conditions data.

Location server 160, in an embodiment, may provide location determination capabilities, transmitter signal acquisition assistance (such as GNSS satellite orbital predictions information, approximate location information, and/or approximate time information), transceiver almanacs such as those containing identification of and location for Wi-Fi access points and base stations, and, in some embodiments, additional information relative to the route such as speed limits, traffic, and road status/construction status.

Map server 150 which may provide map data, such as road locations, points of interest along the road, address locations along the road, road size, road speed limits, traffic conditions, and/or road conditions (wet, slippery, snowy/icy) and road status (open, under construction, accidents).

Environmental data server 140 may, in an embodiment, provide weather- and/or road-related information, traffic information, terrain information, road quality information, speed information, and/or other pertinent environmental data.

Although described separately, it is contemplated that in some embodiments, the functionalities of one or more of the following elements: vehicle information server 155, route server 145, location server 160, map server 150, and environmental data server 140, may be integrated into or referred collectively as a single cloud-based server.

In an embodiment, vehicles 180 and 190 and mobile devices 100, in FIG. 1, may communicate over network 170 via various network access points such as WLAN access point 130 or wireless WAN base station 120 over network 170. Vehicles 180 and 190 and mobile devices 100 may also, in some embodiments, communicate directly between devices, between vehicles, and device to vehicle and vehicle to device using various short-range communications mechanisms to communicate directly without going over network 170, such as via Bluetooth®, Zigbee, and 5G NR standards.

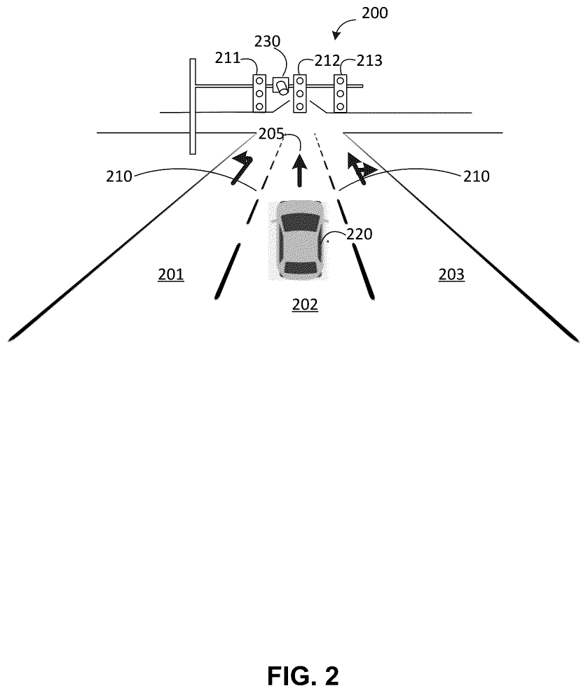

FIG. 2 illustrates an example scenario of a traffic intersection 200 having multi-lane intersections with multiple traffic signal lights. As shown in FIG. 2, traffic intersection 200 may include multiple traffic lanes 201, 202, and 203 and multiple traffic lights 211, 212, and 213. In some embodiments, traffic lanes 201, 202, and 203 may be defined by road markings 210 and may each correspond to one of traffic lights 211, 212, and 213 respectively. As noted above, when a vehicle 220 approaches/presents at traffic intersection 200, a cloud-based server (not shown) may obtain a motion of vehicle 220 at traffic intersection 200 using e.g., traffic camera data (e.g., video frames and/or image frames spanning multiple traffic light cycles) collected by traffic camera(s) 230 during a predetermined time window. In some embodiments, the traffic camera data may be obtained from sources like official traffic management agencies, city databases, third-party services, etc. In some embodiments, the predetermined time window may include multiple traffic light cycles (e.g., including several instances of transitioning from one red light to another).

The cloud-based server may also obtain roadway delineation information (e.g., road marking 210, traffic lanes 201, 202, and 203, ground arrow signs 205, etc.) at traffic intersection 200 corresponding to the motion of vehicle 220 and may obtain traffic light information (e.g., information indicating timing of traffic lights 211, 212, and 213) that indicates timing of a traffic light at traffic intersection 200, corresponding to the time window during which vehicle 220 traverses traffic intersection 200.

For instance, based on the traffic camera data, traffic lane 202 may be connected to or associated with the motion/movement of vehicle 220 (assuming that vehicle 220 proceeds straight across traffic intersection 200 as shown in FIG. 2) if the motion of vehicle 220 remains within the boundaries of traffic lane 202 while traversing traffic intersection 200. On the other hand, traffic light information of a traffic light at traffic intersection 200 (e.g., traffic light 212) corresponding to the time window during which vehicle 220 traverses traffic intersection 200 may be obtained (assuming that during the time window, the motion of vehicle 220 occurs when traffic light 212 turns green, and/or vehicle 220 stops when traffic light 212 turns red).

Accordingly, the traffic signal-to-lane association for a traffic lane (e.g., traffic lane 202) and a traffic light (e.g., traffic light 212) at traffic intersection 200 may be determined by using the information regarding the motion of vehicle 220, roadway delineation information, and the traffic light information.

It is contemplated that although only one vehicle 220 is shown in FIG. 2, motions/movements of more than one vehicle may be obtained during one or more traffic light cycles. Moreover, the signal-to-lane association may be determined at various time periods throughout the day (e.g., at different times of day) to capture the reality of traffic conditions accurately. For example, if the signal-to-lane association changes during the day (e.g., traffic intersection 200 includes a tidal flow lane), the signal-to-lane association may be determined at least twice a day (e.g., before and after the tidal flow change) to better represent the actual traffic situation.

As noted above, in some embodiments, the traffic signal-to-lane association information may be disseminated to AVs through a variety of methods. For example, the traffic signal-to-lane association information may be disseminated using an priori provisioning method. Accordingly, the traffic signal-to-lane association information may be part of a database provisioned in the Avs. In some embodiments, the traffic signal-to-lane association information may be pre-loaded into the AV's onboard systems before it begins its journey. For example, an AV might download the latest traffic signal-to-lane association data for a specific area during a routine software update or when the vehicle is serviced at a maintenance center.

In some embodiments, the traffic signal-to-lane association information may be disseminated to Avs using a location-based knowledge provisioning method. For example, the traffic signal-to-lane association information may be provided to Avs based on their current location. In some embodiments, the traffic signal-to-lane association information can be broadcast at the intersection, such as through an application-layer message. Additionally or alternatively, the traffic signal-to-lane association information may be distributed through dedicated short-range communication (DSRC) systems, cellular networks, or other wireless communication technologies. For instance, as an AV approaches an intersection, the responding cloud-based server might transmit the relevant signal-to-lane association data to the vehicle using a geofencing or proximity-based system (e.g., through a nearby RSU).

In some embodiments, the traffic signal-to-lane association information may be disseminated to Avs using a request-response communication mechanism. For example, Avs may request traffic signal-to-lane association information as needed, and the cloud-based server may respond with the requested data. The lane-signal light association can be transmitted to an AV based on its location, which can be determined from Cooperative Awareness Message (CAM)/Basic Safety Message (BSM) (or other application-layer messages) to a RSU or from in-vehicle location data via Uu to the cloud service. For example, an AV may send a request for the cloud-based service when it approaches the intersection or encounters a situation where it needs the signal-to-lane association data. The response may include the necessary information for that specific intersection or a broader area, depending on the request and available data. In some embodiments, the traffic signal-to-lane association may be embedded in OBU application-layer messages or OBU subscription services. For example, the embedded information may be exchanged between the OBU and the cloud-based server or other connected devices through a communication protocol, which involves sending requests and receiving responses in real-time or near real-time.

In some embodiments, AVs capable of determining their current lane may use pre-provisioned information (e.g., information obtained using the priori provisioning method) or on-the-fly provided (e.g., information obtained using the location-based knowledge provisioning method and/or the request-response communication mechanism). In contrast, AVs unable to determine their current lane may request a RSU (e.g., a camera-equipped RSU) to help determining their current lane.

As noted above, the traffic signal-to-lane association information can be transmitted to the AV through various channels, such as wired connections, over-the-air methods like Wi-Fi downloads facilitated by an OEM or a commercial cloud-based service, or over-the-air through Uu or V2X communication. In some embodiments, the traffic signal-to-lane association information may be transmitted using either application-layer or lower-layer messages (e.g., RRC) from the cloud-based service. In some embodiments, the traffic signal-to-lane association information may be augmented by traffic camera detection of turning signage or turning arrows painted on the road (e.g., ground arrow signs 205).

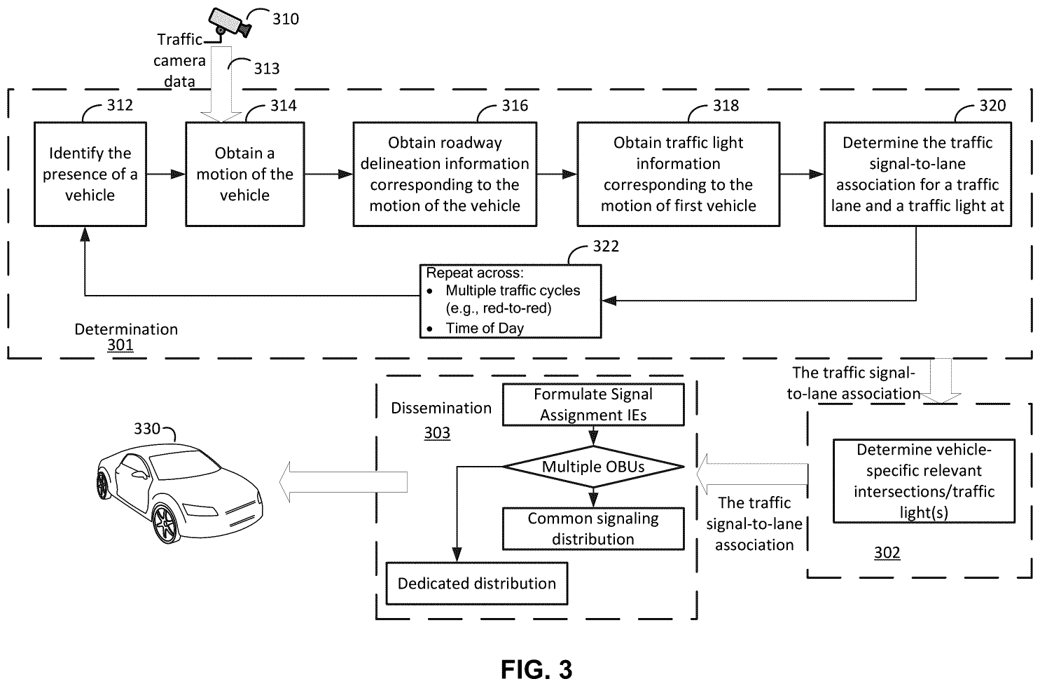

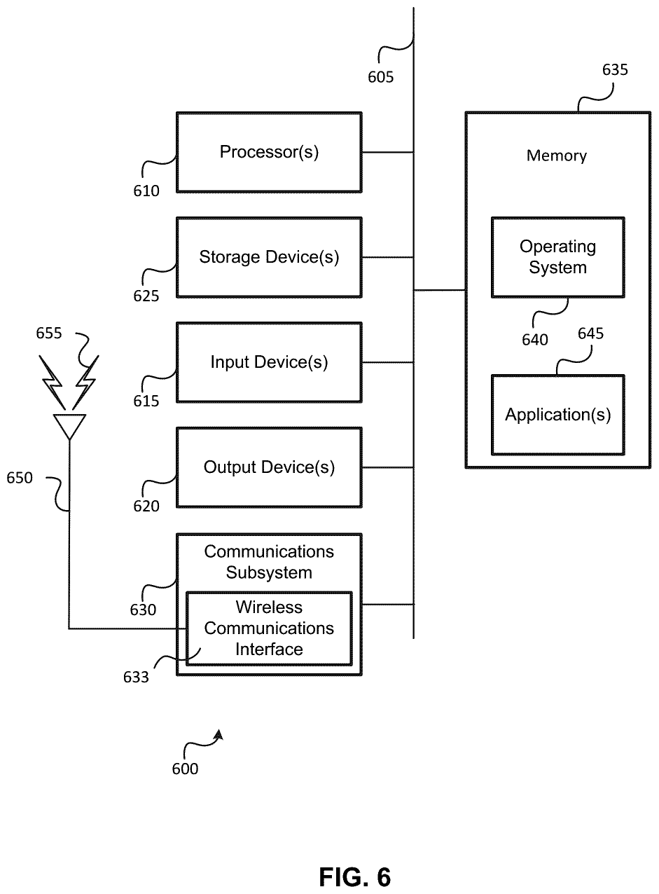

FIG. 3 is a high-level block diagram of a method of traffic camera-based determination of traffic signal-to-lane association for AV operation, according to an embodiment. The functionality illustrated in blocks 301, 302, and 303 may be performed by a cloud-based server as discussed above. The signal-to-lane association determination and dissemination functionalities illustrated in FIG. 3 (e.g., illustrated in blocks 301, 302, and 303) may be performed in conjunction with the description of FIG. 2. Further, the functionality in blocks 301, 302, and 303 may be performed by one or more computer systems, such as the computer system 600 illustrated in FIG. 6. Communication shown in FIG. 3 between different entities (e.g., between any of a traffic camera 310, the cloud-based server, and the V2C device associated with a AV 330) may be facilitated via wired connections and/or a wireless communication network (e.g., a cellular/mobile communication network and/or similar Wireless Wide Area Network (WWAN)).

In block 301, the method may begin with the functionality shown at block 312, in which the cloud-based server may identify the presence of a vehicle at the intersection of interest (e.g., traffic intersection 200 in FIG. 2). In some embodiments, the presence of the vehicle at the intersection of interest may be determined when the vehicle is, or is about to be, within a vicinity (e.g., within a predetermined range) of the intersection of interest. This can be achieved using any suitable positioning mechanism, which may be based on a static position, proximity, or a combination of the vehicle's proximity and heading, or a velocity of the vehicle.

At block 314, the cloud-based server may obtain motion of the vehicle using e.g., traffic camera data such as video frames and/or image frames spanning multiple traffic light cycles. The traffic camera data may be collected by traffic camera(s) 310 during a predetermined time window and may be transmitted in arrow 313. In some embodiments, the traffic camera data may be obtained from sources like official traffic management agencies, city databases, third-party services, etc. In some embodiments, the predetermined time window may include multiple traffic light cycles (e.g., including several instances of transitioning from one red light to another).

At block 316, the cloud-based server may obtain roadway delineation information (e.g., road marking 210, traffic lanes 201, 202, and 203, ground arrow signs 205 in FIG. 2) at the intersection of interest corresponding to the motion of the vehicle as indicated in the traffic data obtained by the traffic camera. For instance, based on the traffic camera data, a traffic lane may be connected to or associated with the motion/movement of the vehicle if the motion of the vehicle remains within the boundaries of the traffic lane while traversing intersection of interest.

At block 318, the cloud-based server may obtain traffic light information at the intersection of interest corresponding to the time window during which the vehicle traverses the traffic intersection. For example, if during the time window, the motion of the vehicle occurs when the traffic light turns green, and/or the vehicle stops when the traffic light turns red, the traffic light may be connected to or associated with the motion/movement of the vehicle.

At block 320, the cloud-based server may determine the traffic signal-to-lane association for the traffic lane and the traffic light at the intersection of interest by using the information regarding the motion of the vehicle, the roadway delineation information, and the traffic light information to associate the traffic light and the traffic lane. For example, the traffic signal-to-lane association for the traffic lanes (e.g., traffic lanes 201, 202, and 203 in FIG. 2) and the traffic lights (e.g., traffic light 211, 212, and 213 in FIG. 2) at the intersection of interest may be determined based on associating the traffic light indicated in the traffic light information and the traffic lane indicated in the roadway delineation information as obtained in blocks 316 and 318.

At block 322, the functionality performed in blocks 312-320 may be repeated on different vehicles, at different predetermined periods of time, and/or at different times of day. For example, as noted above, motions/movements of more than one vehicle may be obtained during one or more traffic light cycles at various time periods throughout the day (e.g., at different times of day) to capture the reality of traffic conditions accurately.

In block 302, the cloud-based server may determine vehicle-specific relevant intersections/traffic light(s) with respect to an AV based on the traffic signal-to-lane association. In some embodiments, the vehicle-specific relevant intersections/traffic light(s) may be determined using location-based knowledge. For example, the traffic signal-to-lane association information may be provided to AVs based on their current location. Additionally or alternatively, in some embodiments, the vehicle-specific relevant intersections/traffic light(s) may be determined in response to a request from a specific AV (e.g., responsive to a determination that the AV is located in the traffic lane of the traffic signal-to-lane association). For example, AVs may request vehicle-specific relevant intersections/traffic light(s) with respect to the AV as needed, and the cloud-based server may determine the vehicle-specific relevant intersections/traffic light(s) accordingly.

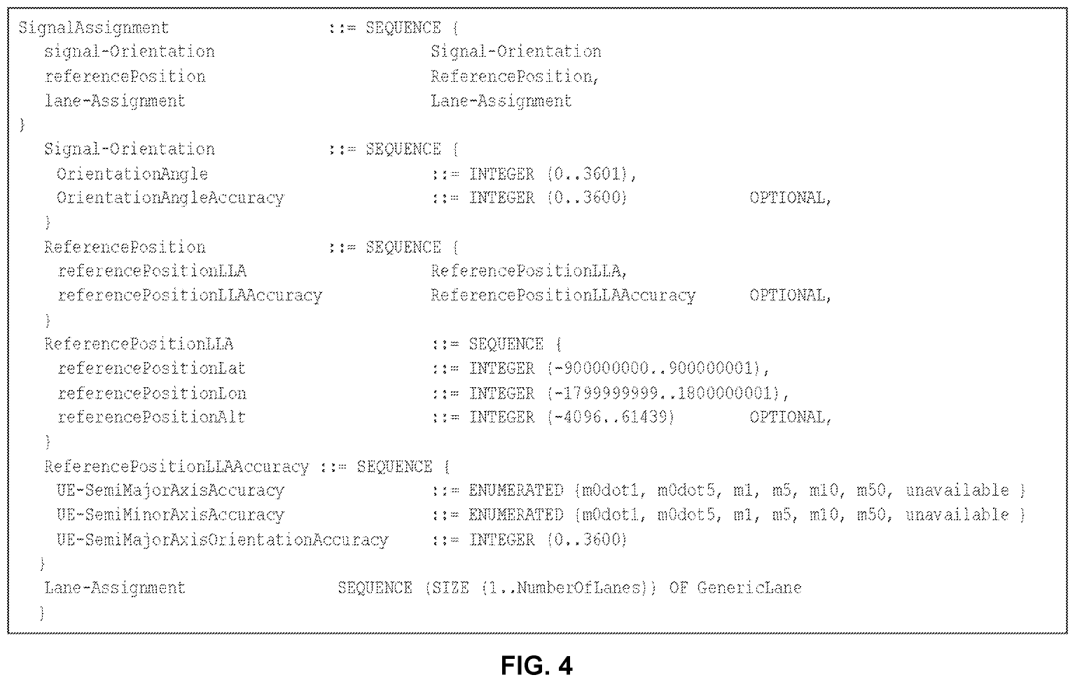

In block 303, the cloud-based server may disseminate the vehicle-specific relevant intersections/traffic light(s) information to AV 330 based on the determination made in block 302. For example, the cloud-based server may formulate signal assignment information elements (IEs) e.g., in accordance with the V2X protocol, such as encapsulating IEs within the V2X payload in application-layer messages. An example of an IE definition is depicted in FIG. 4. The cloud-based server may also determine if more than one AVs are at or approaching the intersection of interest. In some embodiments, depending on the network load, the cloud-based server may disseminate the vehicle-specific relevant intersections/traffic light(s) information based on common or dedicated signaling distribution (e.g., using the PC5 or Uu interface).

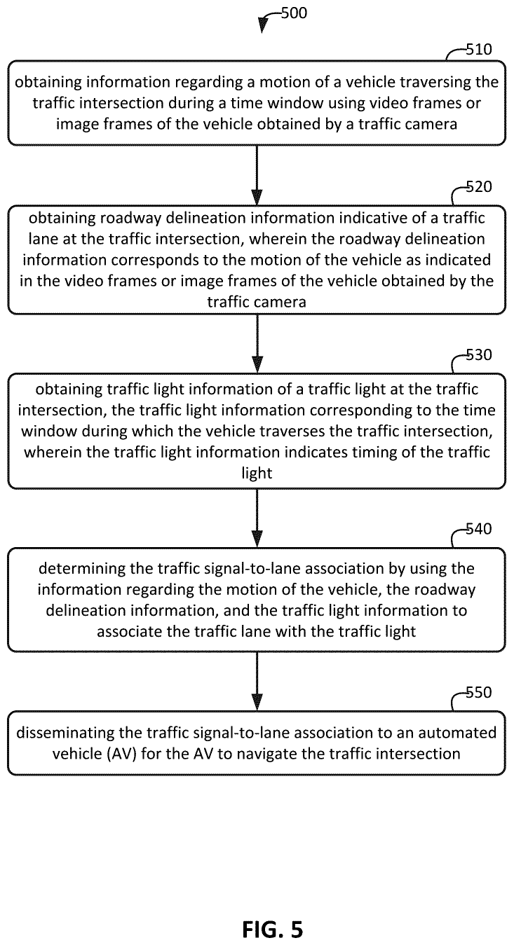

FIG. 5 is a flow diagram of a method 500 of traffic camera-based determination of traffic signal-to-lane association of a traffic intersection for automated vehicle operation, according to some embodiments. In some embodiments, the cloud-based server may correspond to the cloud-based server discussed with respect to FIGS. 2 and 3. Means/structure for performing the functionality illustrated in one or more of the blocks shown in FIG. 5 may be performed by hardware and/or software components of a computer system, as described herein. Example components of a computer system are illustrated in FIG. 6, which are described in more detail below.

At block 510, the functionality comprises obtaining information regarding a motion of a vehicle traversing the traffic intersection during a time window using video frames or image frames of the vehicle obtained by a traffic camera. In some embodiments, the traffic camera data may be obtained from sources like official traffic management agencies, city databases, third-party services, etc. In some embodiments, the predetermined time window may include multiple traffic light cycles (e.g., including several instances of transitioning from one red light to another).

Means for performing functionality at block 510 may comprise a bus 605, processor(s) 610, communications subsystem 630, memory 635, and/or other components of computer system 600, as illustrated in FIG. 6.

At block 520, the functionality comprises obtaining roadway delineation information indicative of a traffic lane at the traffic intersection, wherein the roadway delineation information corresponds to the motion of the vehicle as indicated in the video frames or image frames of the vehicle obtained by the traffic camera. For instance, based on the traffic camera data (e.g., the video frames or image frames of the vehicle), a traffic lane may be connected to or associated with the motion/movement of the vehicle if the motion of the vehicle remains within the boundaries of the traffic lane while traversing intersection of interest.

Means for performing functionality at block 520 may comprise a bus 605, processor(s) 610, communications subsystem 630, memory 635, and/or other components of computer system 600, as illustrated in FIG. 6.

At block 530, the functionality comprises obtaining traffic light information of a traffic light at the traffic intersection, the traffic light information corresponding to the time window during which the vehicle traverses the traffic intersection, wherein the traffic light information indicates timing of the traffic light. For example, if during the time window, the motion of the vehicle occurs when the traffic light turns green, and/or the vehicle stops when the traffic light turns red, the traffic light may be connected to or associated with the motion/movement of the vehicle.

Means for performing functionality at block 530 may comprise a bus 605, processor(s) 610, communications subsystem 630, memory 635, and/or other components of computer system 600, as illustrated in FIG. 6.

At block 540, the functionality comprises determining the traffic signal-to-lane association by using the information regarding the motion of the vehicle, the roadway delineation information, and the traffic light information to associate the traffic lane with the traffic light. For example, the traffic signal-to-lane association for the traffic lanes (e.g., traffic lanes 201, 202, and 203 in FIG. 2) and the traffic lights (e.g., traffic light 211, 212, and 213 in FIG. 2) at the intersection of interest may be determined based on associating the traffic light indicated in the traffic light information and the traffic lane indicated in the roadway delineation information as obtained in blocks 520 and 530.

Means for performing functionality at block 540 may comprise a bus 605, processor(s) 610, communications subsystem 630, memory 635, and/or other components of computer system 600, as illustrated in FIG. 6.

At block 550, the functionality comprises disseminating the traffic signal-to-lane association to an automated vehicle (AV) for the AV to navigate the traffic intersection. For example, the cloud-based server may formulate signal assignment IEs e.g., in accordance with the V2X protocol, such as encapsulating IEs within the V2X payload in application-layer messages. An example of an IE definition is depicted in FIG. 4. The cloud-based server may also determine if more than one AVs are at or approaching the intersection of interest. In some embodiments, depending on the network load, the cloud-based server may disseminate the vehicle-specific relevant intersections/traffic light(s) information based on common or dedicated signaling distribution (e.g., using the PC5 or Uu interface).

As noted above, in some embodiments, the traffic signal-to-lane association information may be disseminated to AVs through a variety of methods. For example, the traffic signal-to-lane association information may be disseminated using a priori provisioning method. Accordingly, the traffic signal-to-lane association information may be part of a database provisioned in the AVs. In some embodiments, the traffic signal-to-lane association information may be pre-loaded into the AV's onboard systems before it begins its journey. For example, an AV might download the latest traffic signal-to-lane association data for a specific area during a routine software update or when the vehicle is serviced at a maintenance center.

In some embodiments, the traffic signal-to-lane association information may be disseminated to AVs using a location-based knowledge provisioning method. For example, the traffic signal-to-lane association information may be provided to AVs based on their current location. In some embodiments, the traffic signal-to-lane association information can be broadcast at the intersection, such as through an application-layer message. Additionally or alternatively, the traffic signal-to-lane association information may be distributed through DSRC systems, cellular networks, or other wireless communication technologies. For instance, as an AV approaches an intersection, the responding cloud-based server might transmit the relevant signal-to-lane association data to the vehicle using a geofencing or proximity-based system (e.g., through a nearby RSU).

In some embodiments, the traffic signal-to-lane association information may be disseminated to AVs using a request-response communication mechanism. For example, AVs may request traffic signal-to-lane association information as needed, and the cloud-based server may respond with the requested data. The lane-signal light association can be transmitted to an AV based on its location, which can be determined from CAM/BSM (or other application-layer messages) to a RSU or from in-vehicle location data via Uu to the cloud service. For example, an AV may send a request for the cloud-based service when it approaches the intersection or encounters a situation where it needs the signal-to-lane association data. The response may include the necessary information for that specific intersection or a broader area, depending on the request and available data. In some embodiments, the traffic signal-to-lane association is embedded in OBU application-layer messages or OBU subscription services. For example, the embedded information may be exchanged between the OBU and a cloud-based server or other connected devices through a communication protocol, which involves sending requests and receiving responses in real-time or near real-time.

In some embodiments, AVs capable of determining their current lane may use pre-provisioned information (e.g., information obtained using the priori provisioning method) or on-the-fly provided (e.g., information obtained using the location-based knowledge provisioning method and/or the request-response communication mechanism). In contrast, AVs unable to determine their current lane may request a RSU (e.g., a camera-equipped RSU) to help determining their current lane.

As noted above, the traffic signal-to-lane association information can be transmitted to the AV through various channels, such as wired connections, over-the-air methods like Wi-Fi downloads facilitated by an OEM or a commercial cloud-based service, or over-the-air through Uu or V2X communication. In some embodiments, the traffic signal-to-lane association information may be transmitted using either application-layer or lower-layer messages (e.g., RRC) from the cloud-based service. In some embodiments, the traffic signal-to-lane association information may be augmented by traffic camera detection of turning signage or turning arrows painted on the road (e.g., ground arrow signs 205).

Means for performing functionality at block 550 may comprise a bus 605, processor(s) 610, communications subsystem 630, memory 635, and/or other components of computer system 600, as illustrated in FIG. 6.

In some embodiments, as noted above, information regarding the motion of the vehicle traversing the traffic intersection may be obtained in response to a determination that the vehicle is present at the traffic intersection. In some embodiments, the presence of the vehicle at the intersection of interest may be determined when the vehicle is, or is about to be, within a vicinity (e.g., within a predetermined range) of the intersection of interest. This can be achieved using any suitable positioning mechanism, which may be based on a static position, proximity, or a combination of the vehicle's proximity and heading, or a velocity of the vehicle.

In some embodiments, disseminating the traffic signal-to-lane association may be performed responsive to a determination that the AV is located in the traffic lane of the traffic signal-to-lane association. In some embodiments, disseminating the traffic signal-to-lane association may be performed by cellular communication interfaces using safety messages. In some embodiments, disseminating the traffic signal-to-lane association may be embedded in on-board unit (OBU) application-layer messages or OBU subscription services.

FIG. 6 is a block diagram of an embodiment of a computer system 600, which may be used, in whole or in part, to provide the functions of one or more components and/or devices as described in the embodiments herein, including a server (e.g., sensing server/SMF, location server/LMF, etc.) in communication with one or more base stations and/or one or more sensing nodes to coordinate RF sensing as described in embodiments herein. This may include, for example, a computer server, personal computer, personal electronic device, or the like. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different geographical locations.

The computer system 600 is shown comprising hardware elements that can be electrically coupled via a bus 605 (or may otherwise be in communication, as appropriate). The hardware elements may include processor(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, a keyboard, a camera (e.g., a traffic camera for obtaining images/traffic camera data), a microphone, and/or the like; and one or more output devices 620, which may comprise without limitation a display device, a printer, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 600 may also include a communications subsystem 630, which may comprise wireless communication technologies managed and controlled by a wireless communication interface 633, as well as wired technologies (such as Ethernet, coaxial communications, universal serial bus (USB), and the like). In some embodiments, the traffic camera data may be received via the communication subsystem 630 (e.g., in case where the traffic camera input is not directly fed to the computer system 600). The wireless communication interface 633 may comprise one or more wireless transceivers that may send and receive wireless signals 655 (e.g., signals according to 5G NR or LTE) via wireless antenna(s) 650. Thus the communications subsystem 630 may comprise a modem, a network card (wireless or wired), an infrared communication device, a wireless communication device, and/or a chipset, and/or the like, which may enable the computer system 600 to communicate on any or all of the communication networks described herein to any device on the respective network, including a User Equipment (UE), base stations and/or other transmission reception points (TRPs), and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

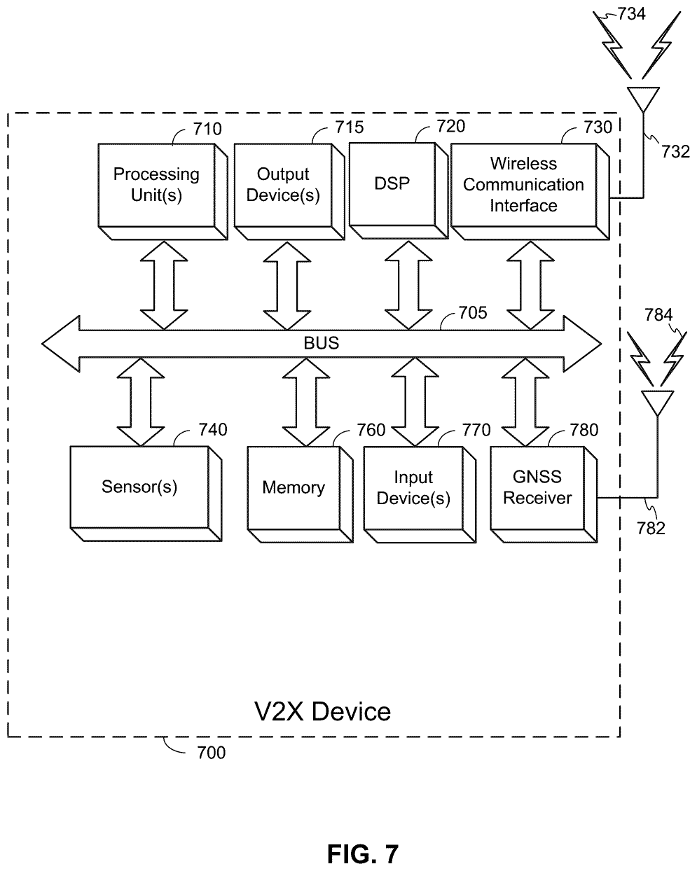

FIG. 7 is a block diagram of an embodiment of a V2X device 700, which may be utilized by and/or integrated into a vehicle, RSU, or any other system or device to wirelessly communicate with vehicles and/or RSUs as previously described. When utilized by a vehicle, the V2X device 700 may comprise or be integrated into a vehicle computer system used to manage one or more systems related to the vehicle's navigation and/or automated driving, as well as communicate with other onboard systems and/or other traffic entities. Moreover, the V2X device 700 may be integrated into an RSU computer system, which may include additional components and may perform additional RSU-related functionality. With this in mind, according to some embodiments, the V2X device 700 may comprise a standalone device or component of a vehicle or RSU, which may be communicatively coupled with other components/devices of the vehicle or RSU. It also can be noted that the V2X device 700 may be utilized in a similar manner by V2X entities other than a vehicle or RSU. Additionally, embodiments may not necessarily be limited to V2X communications. As such, alternative embodiments may include a device similar to the V2X device 700, having similar components to those shown in FIG. 7 and being capable of performing the functions of the vehicles and/or RSU described in the previously discussed embodiments, but without V2X functionality.

It should also be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be located, for example, at different physical locations on a vehicle, RSU, or other V2X entity.

The V2X device 700 is shown comprising hardware elements that can be electrically coupled via a bus 705 (or may otherwise be in communication, as appropriate). The hardware elements may include a processing unit(s) 710 which can include, without limitation, one or more general-purpose processors, one or more special-purpose processors (such as DSP chips, graphics acceleration processors, application-specific integrated circuits (ASICs), and/or the like), and/or other processing structure or means.

The V2X device 700 also can include one or more input devices 770, which can include devices related to user interface (e.g., a touch screen, a touchpad, a microphone, button(s), dial(s), switch(es), and/or the like) and/or devices related to navigation, automated driving, and the like. Similarly, the one or more output devices 715 may be related to interacting with a user (e.g., via a display, light emitting diode(s) (LED(s)), speaker(s)), and/or devices related to navigation, automated driving, and the like.

The V2X device 700 may also include a wireless communication interface 730, which may comprise, without limitation, a modem, a network card, an infrared communication device, a wireless communication device, and/or a chipset (such as a Bluetooth® device, an IEEE 802.11 device, an IEEE 802.15.4 device, a Wi-Fi device, a WiMAX (Worldwide Interoperability for Microwave Access device, a Wide Area Network (WAN) device, and/or various cellular devices), and/or the like. The wireless communication interface 730 can enable the V2X device 700 to communicate to other V2X devices. This can include the various forms of communication of the previously described embodiments, including the messaging illustrated in FIGS. 4A, 4B, and 5. And as such, it may be capable of transmitting direct communications, broadcasting wireless signals, receiving direct and/or broadcast wireless signals, and so forth. Accordingly, the wireless communication interface 730 may be capable of sending and/or receiving RF signals from various RF channels/frequency bands. Communication using the wireless communication interface 730 can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof.

The V2X device 700 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like). Sensor(s) 740 may be used, for example, to determine certain real-time characteristics of the vehicle, such as location, motion state (e.g., velocity, acceleration), and the like. As previously indicated, sensor(s) 740 may be used to help a vehicle determine its location.

Embodiments of the V2X device 700 may also include a Global Navigation Satellite System (GNSS) receiver 780 capable of receiving signals 784 from one or more GNSS satellites using an antenna 782 (which, in some embodiments, may be the same as antenna 732). Positioning based on GNSS signal measurement can be utilized to determine a current location of the V2X device 700 and may further be used as a basis to determine the location of a detected object. The GNSS receiver 780 can extract a position of the V2X device 700, using conventional techniques, from GNSS satellites of a GNSS system, such as Global Positioning System (GPS) and/or similar satellite systems.

The V2X device 700 may further comprise and/or be in communication with a memory 760. The memory 760 can include, without limitation, local and/or network accessible storage, a disk drive, a drive array, an optical storage device, a solid-state storage device (such as a random-access memory (RAM) and/or a read-only memory (ROM)), which can be programmable, flash-updateable, and/or the like. Such storage devices may be configured to implement any appropriate data stores, including, without limitation, various file systems, database structures, and/or the like.

The memory 760 of the V2X device 700 also can comprise software elements (not shown in FIG. 7), including an operating system, device drivers, executable libraries, and/or other code, such as one or more application programs, which may comprise computer programs provided by various embodiments, and/or may be designed to implement methods and/or configure systems as described herein. Software applications stored in memory 760 and executed by processing unit(s) 710 may be used to implement the functionality of a vehicle or RSU as described herein. Moreover, one or more procedures described with respect to the method(s) discussed herein may be implemented as code and/or instructions in memory 760 that are executable by the V2X device 700 (and/or processing unit(s) 710 or DSP 720 within V2X device 700), including the functions illustrated in the methods of FIGS. 6 and 7. In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. An example method of traffic camera-based determination of traffic signal-to-lane association of a traffic intersection for automated vehicle operation, the method performed by a server and may comprise obtaining information regarding a motion of a vehicle traversing the traffic intersection during a time window using video frames or image frames of the vehicle obtained by a traffic camera and obtaining roadway delineation information indicative of a traffic lane at the traffic intersection, wherein the roadway delineation information corresponds to the motion of the vehicle as indicated in the video frames or image frames of the vehicle obtained by the traffic camera. The method may also comprise obtaining traffic light information of a traffic light at the traffic intersection, the traffic light information corresponding to the time window during which the vehicle traverses the traffic intersection, wherein the traffic light information indicates timing of the traffic light and determining the traffic signal-to-lane association by using the information regarding the motion of the vehicle, the roadway delineation information, and the traffic light information to associate the traffic lane with the traffic light. The method may further comprise disseminating the traffic signal-to-lane association to an automated vehicle (AV) for the AV to navigate the traffic intersection.
Clause 2. The method of clause 1, wherein information regarding the motion of the vehicle traversing the traffic intersection is obtained in response to a determination that the vehicle is present at the traffic intersection.
Clause 3. The method of any of clause 1 or 2, wherein the determination that the vehicle is present at the traffic intersection is based on: a static position of the vehicle; a proximity of the vehicle to the traffic intersection; a velocity of the vehicle; or any combination thereof.
Clause 4. The method of any of clauses 1-3, wherein disseminating the traffic signal-to-lane association is performed based on: a priori provisioning method; a location-based knowledge provisioning method; a request-response communication mechanism; or any combination thereof.
Clause 5. The method of any of clauses 1-4, wherein disseminating the traffic signal-to-lane association is responsive to a determination that the AV is located in the traffic lane of the traffic signal-to-lane association.
Clause 6. The method of any of clauses 1-5, disseminating the traffic signal-to-lane association is performed by cellular communication interfaces using safety messages.
Clause 7. The method of any of clauses 1-6, wherein the traffic signal-to-lane association is embedded in on-board unit (OBU) application-layer messages or OBU subscription services.
Clause 8. The method of any of clauses 1-7, wherein the time window comprises at least one traffic light cycle.
Clause 9. An example server for traffic camera-based determination of traffic signal-to-lane association of a traffic intersection for automated vehicle operation, the radar unit comprising a transceiver, a memory, and one or more processors communicatively coupled with the transceiver and the memory. The one or more processors may be configured to obtain information regarding a motion of a vehicle traversing the traffic intersection during a time window using video frames or image frames of the vehicle obtained by a traffic camera and obtain roadway delineation information indicative of a traffic lane at the traffic intersection, wherein the roadway delineation information corresponds to the motion of the vehicle as indicated in the video frames or image frames of the vehicle obtained by the traffic camera. The one or more processors may also be configured to obtain traffic light information of a traffic light at the traffic intersection, the traffic light information corresponding to the time window during which the vehicle traverses the traffic intersection, wherein the traffic light information indicates timing of the traffic light and determine the traffic signal-to-lane association by using the information regarding the motion of the vehicle, the roadway delineation information, and the traffic light information to associate the traffic lane with the traffic light. The one or more processors may further be configured to disseminate the traffic signal-to-lane association to an automated vehicle (AV) for the AV to navigate the traffic intersection.
Clause 10. The server of clause 9, wherein information regarding the motion of the vehicle traversing the traffic intersection is obtained in response to a determination that the vehicle is present at the traffic intersection.
Clause 11. The server of any of clause 9 or 10, wherein the determination that the vehicle is present at the traffic intersection is based on: a static position of the vehicle; a proximity of the vehicle to the traffic intersection; a velocity of the vehicle; or any combination thereof.
Clause 12. The server of any of clauses 9-11, wherein disseminating the traffic signal-to-lane association is performed based on: a priori provisioning method; a location-based knowledge provisioning method; a request-response communication mechanism; or any combination thereof.
Clause 13. The server of any of clauses 9-12, wherein disseminating the traffic signal-to-lane association is responsive to a determination that the AV is located in the traffic lane of the traffic signal-to-lane association.
Clause 14. The server of any of clauses 9-13, disseminating the traffic signal-to-lane association is performed by cellular communication interfaces using safety messages.
Clause 15. The server of any of clauses 9-14, wherein the traffic signal-to-lane association is embedded in on-board unit (OBU) application-layer messages or OBU subscription services.
Clause 16. An example apparatus for traffic camera-based determination of traffic signal-to-lane association of a traffic intersection for automated vehicle operation, the apparatus may comprise means for obtaining information regarding a motion of a vehicle traversing the traffic intersection during a time window using video frames or image frames of the vehicle obtained by a traffic camera and means for obtaining roadway delineation information indicative of a traffic lane at the traffic intersection, wherein the roadway delineation information corresponds to the motion of the vehicle as indicated in the video frames or image frames of the vehicle obtained by the traffic camera. The apparatus may also comprise means for obtaining traffic light information of a traffic light at the traffic intersection, the traffic light information corresponding to the time window during which the vehicle traverses the traffic intersection, wherein the traffic light information indicates timing of the traffic light and means for determining the traffic signal-to-lane association by using the information regarding the motion of the vehicle, the roadway delineation information, and the traffic light information to associate the traffic lane with the traffic light. The apparatus may further comprise means for disseminating the traffic signal-to-lane association to an automated vehicle (AV) for the AV to navigate the traffic intersection.
Clause 17. The apparatus of clause 16, wherein information regarding the motion of the vehicle traversing the traffic intersection is obtained in response to a determination that the vehicle is present at the traffic intersection.
Clause 18. The apparatus of any of clause 16 or 17, wherein the determination that the vehicle is present at the traffic intersection is based on: a static position of the vehicle; a proximity of the vehicle to the traffic intersection; a velocity of the vehicle; or any combination thereof.
Clause 19. The apparatus of any of clauses 16-18, wherein disseminating the traffic signal-to-lane association is performed based on: a priori provisioning method; a location-based knowledge provisioning method; a request-response communication mechanism; or any combination thereof.
Clause 20. The apparatus of any of clauses 16-19, wherein disseminating the traffic signal-to-lane association is responsive to a determination that the AV is located in the traffic lane of the traffic signal-to-lane association.
Clause 21. The apparatus of any of clauses 16-20, disseminating the traffic signal-to-lane association is performed by cellular communication interfaces using safety messages.
Clause 22. The apparatus of any of clauses 16-21, wherein the traffic signal-to-lane association is embedded in on-board unit (OBU) application-layer messages or OBU subscription services.
Clause 23. The apparatus of any of clauses 16-22, wherein the time window comprises at least one traffic light cycle.
Clause 24. An example non-transitory computer-readable medium storing instructions for traffic camera-based determination of traffic signal-to-lane association of a traffic intersection for automated vehicle operation, the instructions may comprise code for obtaining information regarding a motion of a vehicle traversing the traffic intersection during a time window using video frames or image frames of the vehicle obtained by a traffic camera and obtaining roadway delineation information indicative of a traffic lane at the traffic intersection, wherein the roadway delineation information corresponds to the motion of the vehicle as indicated in the video frames or image frames of the vehicle obtained by the traffic camera. The instructions may also comprise code for obtaining traffic light information of a traffic light at the traffic intersection, the traffic light information corresponding to the time window during which the vehicle traverses the traffic intersection, wherein the traffic light information indicates timing of the traffic light and determining the traffic signal-to-lane association by using the information regarding the motion of the vehicle, the roadway delineation information, and the traffic light information to associate the traffic lane with the traffic light. The instructions may further comprise code for disseminating the traffic signal-to-lane association to an automated vehicle (AV) for the AV to navigate the traffic intersection.
Clause 25. The non-transitory computer-readable medium of clause 24, wherein information regarding the motion of the vehicle traversing the traffic intersection is obtained in response to a determination that the vehicle is present at the traffic intersection.
Clause 26. The non-transitory computer-readable medium of any of clause 24 or 25, wherein the determination that the vehicle is present at the traffic intersection is based on: a static position of the vehicle; a proximity of the vehicle to the traffic intersection; a velocity of the vehicle; or any combination thereof.
Clause 27. The non-transitory computer-readable medium of any of clauses 24-26, wherein disseminating the traffic signal-to-lane association is performed based on: a priori provisioning method; a location-based knowledge provisioning method; a request-response communication mechanism; or any combination thereof.
Clause 28. The non-transitory computer-readable medium of any of clauses 24-27, wherein disseminating the traffic signal-to-lane association is responsive to a determination that the AV is located in the traffic lane of the traffic signal-to-lane association.
Clause 29. The non-transitory computer-readable medium of any of clauses 24-28, wherein disseminating the traffic signal-to-lane association is performed by cellular communication interfaces using safety messages.
Clause 30. The non-transitory computer-readable medium of any of clauses 24-29, wherein the traffic signal-to-lane association is embedded in on-board unit (OBU) application-layer messages or OBU subscription services.

What is claimed is:

1. A method of traffic camera-based determination of traffic signal-to-lane association of a traffic intersection for automated vehicle operation, the method performed by a server and comprising:
obtaining information regarding a motion of a vehicle traversing the traffic intersection during a time window using video frames or image frames of the vehicle obtained by a traffic camera;
obtaining roadway delineation information indicative of a traffic lane at the traffic intersection, wherein the roadway delineation information corresponds to the motion of the vehicle as indicated in the video frames or image frames of the vehicle obtained by the traffic camera;
obtaining traffic light information of a traffic light at the traffic intersection, the traffic light information corresponding to the time window during which the vehicle traverses the traffic intersection, wherein the traffic light information indicates timing of the traffic light;
determining the traffic signal-to-lane association by using the information regarding the motion of the vehicle, the roadway delineation information, and the traffic light information to associate the traffic lane with the traffic light; and
disseminating the traffic signal-to-lane association to an automated vehicle (AV) for the AV to navigate the traffic intersection.

2. The method of claim 1, wherein information regarding the motion of the vehicle traversing the traffic intersection is obtained in response to a determination that the vehicle is present at the traffic intersection.

3. The method of claim 1, wherein the determination that the vehicle is present at the traffic intersection is based on:
a static position of the vehicle;
a proximity of the vehicle to the traffic intersection;
a velocity of the vehicle; or
any combination thereof.

4. The method of claim 1, wherein disseminating the traffic signal-to-lane association is performed based on:
a priori provisioning method;
a location-based knowledge provisioning method;
a request-response communication mechanism; or
any combination thereof.

5. The method of claim 1, wherein disseminating the traffic signal-to-lane association is responsive to a determination that the AV is located in the traffic lane of the traffic signal-to-lane association.

6. The method of claim 1, wherein disseminating the traffic signal-to-lane association is performed by cellular communication interfaces using safety messages.

7. The method of claim 1, wherein the traffic signal-to-lane association is embedded in on-board unit (OBU) application-layer messages or OBU subscription services.

8. The method of claim 1, wherein the time window comprises at least one traffic light cycle.

9. A server for traffic camera-based determination of traffic signal-to-lane association of a traffic intersection for automated vehicle operation, the server comprising:
a transceiver;
a memory; and
one or more processors communicatively coupled with the transceiver and the memory, wherein the one or more processors are configured to:
obtain information regarding a motion of a vehicle traversing the traffic intersection during a time window using video frames or image frames of the vehicle obtained by a traffic camera;
obtain roadway delineation information indicative of a traffic lane at the traffic intersection, wherein the roadway delineation information corresponds to the motion of the vehicle as indicated in the video frames or image frames of the vehicle obtained by the traffic camera;
obtain traffic light information of a traffic light at the traffic intersection, the traffic light information corresponding to the time window during which the vehicle traverses the traffic intersection, wherein the traffic light information indicates timing of the traffic light;
determine the traffic signal-to-lane association by using the information regarding the motion of the vehicle, the roadway delineation information, and the traffic light information to associate the traffic lane with the traffic light; and
disseminate the traffic signal-to-lane association to an automated vehicle (AV) for the AV to navigate the traffic intersection.

10. The server of claim 9, wherein information regarding the motion of the vehicle traversing the traffic intersection is obtained in response to a determination that the vehicle is present at the traffic intersection.

11. The server of claim 9, wherein the determination that the vehicle is present at the traffic intersection is based on:
a static position of the vehicle;
a proximity of the vehicle to the traffic intersection;
a velocity of the vehicle; or
any combination thereof.

12. The server of claim 9, wherein disseminating the traffic signal-to-lane association is performed based on:
a priori provisioning method;
a location-based knowledge provisioning method;
a request-response communication mechanism; or
any combination thereof.

13. The server of claim 9, wherein disseminating the traffic signal-to-lane association is responsive to a determination that the AV is located in the traffic lane of the traffic signal-to-lane association.

14. The server of claim 9, wherein disseminating the traffic signal-to-lane association is performed by cellular communication interfaces using safety messages.

15. The server of claim 9, wherein the traffic signal-to-lane association is embedded in on-board unit (OBU) application-layer messages or OBU subscription services.

16. An apparatus for traffic camera-based determination of traffic signal-to-lane association of a traffic intersection for automated vehicle operation, the apparatus comprising:
means for obtaining information regarding a motion of a vehicle traversing the traffic intersection during a time window using video frames or image frames of the vehicle obtained by a traffic camera;
means for obtaining roadway delineation information indicative of a traffic lane at the traffic intersection, wherein the roadway delineation information corresponds to the motion of the vehicle as indicated in the video frames or image frames of the vehicle obtained by the traffic camera;
means for obtaining traffic light information of a traffic light at the traffic intersection, the traffic light information corresponding to the time window during which the vehicle traverses the traffic intersection, wherein the traffic light information indicates timing of the traffic light;
means for determining the traffic signal-to-lane association by using the information regarding the motion of the vehicle, the roadway delineation information, and the traffic light information to associate the traffic lane with the traffic light; and
means for disseminating the traffic signal-to-lane association to an automated vehicle (AV) for the AV to navigate the traffic intersection.

17. The apparatus of claim 16, wherein information regarding the motion of the vehicle traversing the traffic intersection is obtained in response to a determination that the vehicle is present at the traffic intersection.

18. The apparatus of claim 16, wherein the determination that the vehicle is present at the traffic intersection is based on:
a static position of the vehicle;
a proximity of the vehicle to the traffic intersection;
a velocity of the vehicle; or
any combination thereof.

19. The apparatus of claim 16, wherein disseminating the traffic signal-to-lane association is performed based on:
a priori provisioning method;
a location-based knowledge provisioning method;
a request-response communication mechanism; or
any combination thereof.

20. The apparatus of claim 16, wherein disseminating the traffic signal-to-lane association is responsive to a determination that the AV is located in the traffic lane of the traffic signal-to-lane association.

21. The apparatus of claim 16, wherein disseminating the traffic signal-to-lane association is performed by cellular communication interfaces using safety messages.

22. The apparatus of claim 16, wherein the traffic signal-to-lane association is embedded in on-board unit (OBU) application-layer messages or OBU subscription services.

23. The apparatus of claim 16, wherein the time window comprises at least one traffic light cycle.

24. A non-transitory computer-readable medium storing instructions for traffic camera-based determination of traffic signal-to-lane association of a traffic intersection for automated vehicle operation, the instructions comprising code for:
obtaining information regarding a motion of a vehicle traversing the traffic intersection during a time window using video frames or image frames of the vehicle obtained by a traffic camera;
obtaining roadway delineation information indicative of a traffic lane at the traffic intersection, wherein the roadway delineation information corresponds to the motion of the vehicle as indicated in the video frames or image frames of the vehicle obtained by the traffic camera;
obtaining traffic light information of a traffic light at the traffic intersection, the traffic light information corresponding to the time window during which the vehicle traverses the traffic intersection, wherein the traffic light information indicates timing of the traffic light;
determining the traffic signal-to-lane association by using the information regarding the motion of the vehicle, the roadway delineation information, and the traffic light information to associate the traffic lane with the traffic light; and
disseminating the traffic signal-to-lane association to an automated vehicle (AV) for the AV to navigate the traffic intersection.

25. The computer-readable medium of claim 24, wherein information regarding the motion of the vehicle traversing the traffic intersection is obtained in response to a determination that the vehicle is present at the traffic intersection.

26. The computer-readable medium of claim 24, wherein the determination that the vehicle is present at the traffic intersection is based on:
a static position of the vehicle;
a proximity of the vehicle to the traffic intersection;
a velocity of the vehicle; or
any combination thereof.

27. The computer-readable medium of claim 24, wherein disseminating the traffic signal-to-lane association is performed based on:
a priori provisioning method;
a location-based knowledge provisioning method;
a request-response communication mechanism; or
any combination thereof.

28. The computer-readable medium of claim 24, wherein disseminating the traffic signal-to-lane association is responsive to a determination that the AV is located in the traffic lane of the traffic signal-to-lane association.

29. The computer-readable medium of claim 24, wherein disseminating the traffic signal-to-lane association is performed by cellular communication interfaces using safety messages.

30. The computer-readable medium of claim 24, wherein the traffic signal-to-lane association is embedded in on-board unit (OBU) application-layer messages or OBU subscription services.
